(19) United States
(12) Patent Application Publication
(10) Pub. No.: US 2011/0228745 A1
(43) Pub. Date: Sep. 22, 2011

(54) METHOD, APPARATUS, AND SYSTEM FOR TRANSMITTING A HOPPING PILOT BEACON AND METHOD FOR DIRECTING A TERMINAL HANDOFF

(76) Inventor: Shusheng LI, Shenzhen (CN)

(21) Appl. No.: 13/150,466

(22) Filed: Jun. 1, 2011

Related U.S. Application Data
(63) Continuation of application No. PCT/CN2009/075253, filed on Dec. 2, 2009.

(30) Foreign Application Priority Data
Dec. 3, 2008 (CN) 200810204154.7

(51) Int. Cl. H04B 7/26; H04W 4/00

(52) U.S. Cl. 370/331; 455/525

(57) ABSTRACT

The present invention discloses a method for transmitting a Hopping Pilot Beacon (HPB). The method includes the following steps: an HPB cell selects one resource among remaining resources used to transmit a traffic carrier frequency; the HPB cell uses the selected resource to transmit information on each of HPB frequencies rotationally and periodically, where the information on each of HPB frequencies includes the same SYNC, PILOT, and PAGING channel parameters. The present invention also discloses a method for directing a Mobile Station (MS) in an idle state to complete an inter-frequency handoff, an HPB transmitting apparatus, and a communications system thereof. The present invention helps to reduce the system cost and can direct an MS in the idle state to complete an inter-frequency handoff quickly.

### CROSS-REFERENCE TO RELATED APPLICATIONS

This application is a continuation of International Application No. PCT/CN2009/075253, filed on Dec. 2, 2009, which claims priority to Chinese Patent Application No. 200810204154.7, filed on Dec. 3, 2008, both of which are hereby incorporated by reference in their entireties.

### FIELD OF THE INVENTION

The present invention relates to mobile communications, and in particular, to a method for transmitting a Hopping Pilot Beacon (HPB), a method for a Mobile Station (MS) in an idle state to perform an inter-frequency handoff, an apparatus for transmitting an HPB, and a communications system.

### BACKGROUND OF THE INVENTION

In a mobile communications system, when an MS moves between neighbor cells served by different base stations, a handoff procedure is required. When the traffic carrier frequencies of the neighbor cells are different, an idle or active inter-frequency handoff procedure is required. Because an MS in the idle state is unable to search for inter-frequency neighbor cells, a Pilot Beacon (PB) is often used to direct the inter-frequency handoff procedure.

Taking continuously transmitted non-hopping PBs as an example, as shown in FIG. 1, the Base Station Controller (BSC) serving City 1 is BSC 2, and its traffic carrier frequency is F1; the BSC serving City 2 is BSC 1, and its traffic carrier frequency is F2. To implement an inter-frequency handoff, BSC 1 sets a PB cell B1-1 with the frequency F1, and adds the cell B1-1 to the neighbor cell list of the border cell B2-1 of BSC 2; BSC 2 sets a PB cell B2-2 with the frequency F2 and adds the cell B2-2 to the neighbor cell list of the border cell B1-2 of BSC 1. With respect to an idle handoff, if the MS moves from City 1 to City 2, when the MS camping on F1 crosses the border, the MS will discover that the same pilot strength Ec/Io of the neighbor cell B1-1 is stronger than that of B2-1 and will therefore initiate an idle handoff to F1 of the PB cell B1-1. Therefore, an same handoff is completed. After the MS switches to B1-1, the MS obtains information about SYNC and PAGING channels and is finally redirected to F2 through a Code Division Multiple Access (CDMA) Channel List Message (CCLM) of the PAGING channel, so that an inter-frequency handoff is completed. Therefore, in the case of an idle handoff, in addition to the PILOT channel, the SYNC channel and PAGING channel must be set for the PB. With respect to an active handoff, if the MS moves from City 1 to City 2, when the MS camping on F1 crosses the border, the MS will discover that the same pilot strength Ec/Io of the neighbor cell B1-1 can be included in the active set. Then the MS sends a Pilot Strength Measurement Message (PSMM) to BSC 2. BSC 2 discovers that the cell B1-1 related to the pilot information carried in the PSMM is set as a PB cell and directs the MS to switch to the traffic carrier frequency through a hard handoff. Therefore, to direct the MS to perform an active handoff, the system only needs to set or transmit PILOT channel information.

If multiple frequencies exist at the inter-frequency border, the Hopping Pilot Beacon (HPB) must be used. For example, City 1 is covered by F1, F2, F3, and F4, and the traffic carrier frequency in City 2 is F5. Then, for the BSC 1 of City 2, the PB of F1, F2, F3, and F4 must be set at the network border. To reduce the cost and reduce the same interference of BSC 2, the PB cell can transmit the PB in a hopping manner, which is described as an HPB, as shown in FIG. 2.

Currently, an HPB solution usually adopts the apparatus shown in FIG. 3. In the apparatus, the HPB function is provided by external hardware, an HPB apparatus. Specifically, the ingress line of a −60 dB coupler receives a traffic carrier frequency signal from a Base Transceiver Station (BTS) and outputs two signals. Both signals carry information on all CDMA channels, including PILOT, SYNC, and PAGING in the traffic carrier frequency signal received on the ingress line. The HPB apparatus obtains the PILOT channel information from one signal split from the −60 dB coupler and changes the frequency periodically according to different hopping frequencies. Finally, the PILOT channel information is transmitted from an antenna together with the traffic carrier frequency signal through a synthesizer. The PILOT channel information is not a modulated spread spectrum signal. The PILOT channel information obtained from the line signal needs no demodulation. The processing is simple. The SYNC and PAGING channel information, however, is encoded, interleaved, spread, and modulated. To obtain SYNC and PAGING channel information from the line signal, demodulation and decoding are required and the processing is complicated, resulting in a high cost. Taken this into consideration, currently, the HPB apparatus will generally not extract the SYNC and PAGING channel information from the line signal and cannot transmit the SYNC and PAGING channel information either. Because the HPB apparatus is unable to transmit SYNC and PAGING channel information, it cannot direct the MS to complete an inter-frequency handoff when the MS is idle.

### SUMMARY OF THE INVENTION

The purpose of the embodiments of the present invention is to provide a method for transmitting an HPB and a method for directing an MS in the idle state to complete an inter-frequency handoff, in order to overcome the inability of the prior art to direct, an MS in the idle state to complete an inter-frequency handoff because the HPB transmitting apparatus does not transmit the SYNC and PAGING channel information.

To achieve the purpose, a method for transmitting an HPB according to an embodiment of the present invention includes:

selecting, by an HPB cell, one resource among remaining resources used to transmit a traffic carrier frequency; and

using, by the HPB cell, the selected resource to transmit information on each of HPB frequencies rotationally and periodically, where:

the information on each HPB frequency includes the same SYNC, PILOT, and PAGING channel parameters.

A method for directing an MS in an idle state to complete an inter-frequency handoff according to an embodiment of the present invention includes:

selecting, by a target cell, one resource among remaining resources used to transmit a traffic carrier frequency and using the selected resource to transmit information on each of HPB frequencies rotationally and periodically, where the information on each HPB frequency includes the same SYNC, PILOT and PAGING channel parameters;

initiating, by the MS, an idle handoff to an HPB frequency in the target cell which is the same as a traffic carrier frequency where the MS is currently camping; and

by the MS, getting a SYNC channel and a PAGING channel on the target HPB frequency and being redirected to a traffic carrier frequency of the target cell through a message on the PAGING channel.

An HPB transmitting apparatus according to an embodiment of the present invention includes:

a selecting unit, configured to select one resource among remaining resources used to transmit a traffic carrier frequency;

a transmitting unit, configured to use the selected resource to transmit information on each of HPB frequencies rotationally and periodically; and

a setting unit, configured to set the same SYNC, PILOT, and PAGING channel parameters in the transmitted information on HPB frequencies.

A communications system according to an embodiment of the present invention includes an HPB transmitting apparatus and an MS, where:

the HPB transmitting apparatus is configured to: select one resource among remaining resources used to transmit a traffic carrier frequency, use the selected resource to transmit information on each of HPB frequencies rotationally and periodically, and set the same SYNC, PILOT and PAGING channel parameters in the transmitted information on HPB frequencies; and

the MS, when initiating an idle handoff, switches to an HPB frequency which is transmitted by the HPB transmitting apparatus, and is, the same as a traffic carrier frequency where the MS is currently camping, obtains information about a SYNC channel and a PAGING channel on the target HPB frequency, and is redirected to a traffic carrier frequency of the target cell through a message on the PAGING channel.

Evidently, the idle resource selected for the HPB can set and transmit the SYNC and PAGING channels and therefore can direct the MS in the idle state to complete an inter-frequency handoff. In addition, the embodiments of the present invention can transmit the SYNC and PAGING channels by using the selected idle resource without the need to add a new device as in the prior art to transmit the channels. Therefore, compared with the prior art, the embodiments of the present invention can direct the MS in the idle state to complete an inter-frequency handoff without increasing the system cost.

### BRIEF DESCRIPTION OF THE DRAWINGS

FIG. 1 is a schematic diagram illustrating configuration of a non-hopping PB in a prior art;

FIG. 2 is a schematic diagram illustrating time sequence of HPB transmission in a prior art;

FIG. 3 is a schematic diagram of an HPB transmitting apparatus in a prior art;

FIG. 4 is a flowchart of a method for transmitting an HPB according to an embodiment of the present invention;

FIG. 5a is a schematic diagram illustrating an implementation of an apparatus in a scenario where three HPB frequencies are available in a same HPB cell according to an embodiment of the present invention;

FIG. 5b is a schematic diagram of time sequence in which the apparatus shown in FIG. 5a transmits three HPB frequencies;

FIG. 6 is a flowchart of a method for an MS in the idle state to perform an inter-frequency handoff according to an embodiment of the present invention;

FIG. 7 is a schematic diagram illustrating how an MS moves from a current cell to a target cell and completes an inter-frequency handoff according to an embodiment of the present invention;

FIG. 8 is a schematic diagram of an HPB transmitting apparatus according to an embodiment of the present invention; and

FIG. 9 is a schematic diagram of a communications system: according to an embodiment of the present invention.

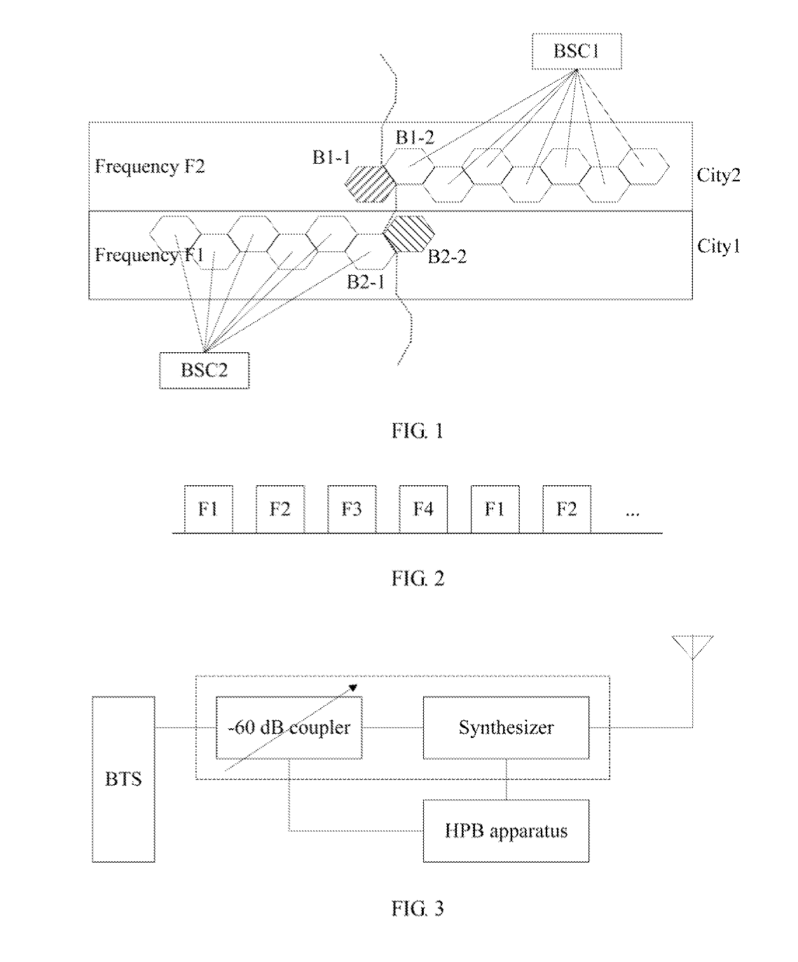

### DETAILED DESCRIPTION OF THE EMBODIMENTS

In the embodiments of the present invention, an HPB is transmitted by one resource selected among the remaining resources that are used to transmit a traffic carrier frequency in a system. This is intended to solve the problem in the prior art that an additional hardware apparatus cannot direct an MS in an idle state to complete an inter-frequency handoff when the hardware apparatus transmits, the HPB. This also, helps to save the cost of hardware.

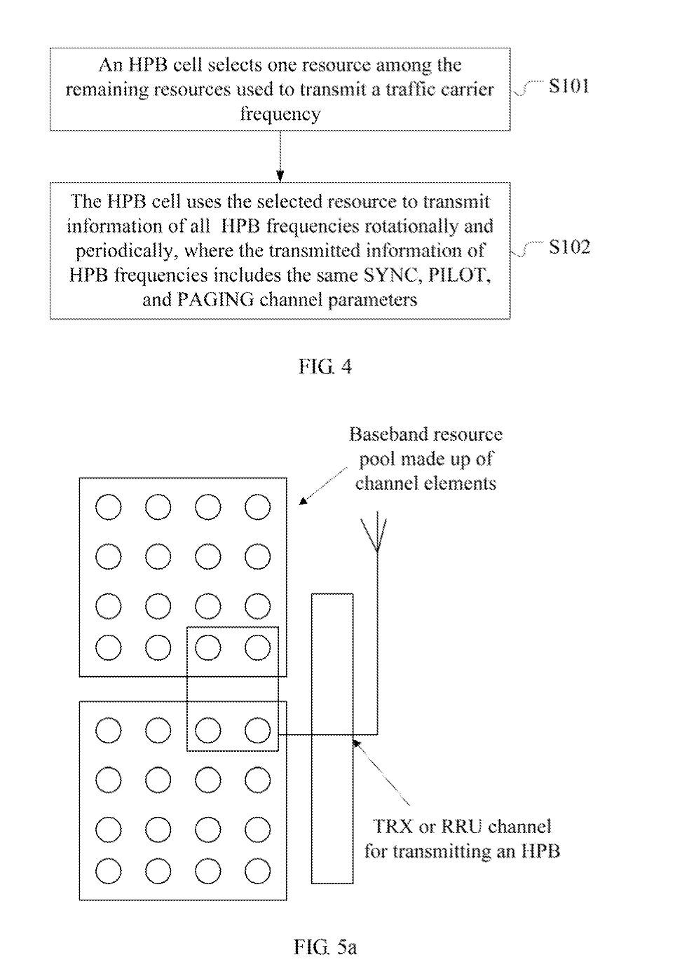

The embodiments of the present invention are described with reference to the accompanying drawings. FIG. 4 illustrates a method for transmitting, an HPB in an embodiment of the present invention. The method includes the following steps:

Step S101: An HPB cell selects one resource among the remaining, resources that are used to transmit a traffic carrier frequency.

The HPB cell is a cell where an HPB must be set or a cell to be set with an HPB.

Step S102: The HPB cell uses the selected resource to transmit information on each of the HPB frequencies rotationally and periodically. The transmitted information on different frequencies of the HPB carries SYNC, PILOT, and PAGING channel parameters of the same configuration.

The selected resource used to transmit information on different frequencies of the HPB rotationally and periodically includes: a baseband resource and an intermediate radio frequency resource. The baseband resource is used for performing processing according to the information on different frequencies of the HPB, such as performing encoding, interleaving, and modulation information on and used for generating an output baseband signal that carries the information on different frequencies of the HPB. The intermediate radio frequency resource is used for generating an intermediate radio frequency carrier signal according to the information on different frequencies of the HPB, superposing the intermediate radio frequency carrier signal and the output baseband signal, and transmitting the signals together. Generally, the baseband resource may be a channel element, horsepower, or encoding time, and the intermediate radio frequency resource may be a transceiving channel of a Transceiver (TRX) or Remote Radio Unit (RRU).

If there are multiple frequencies of the HPB in a same HPB cell, an implementation of selecting one resource to transmit information on different frequencies of the HPB rotationally and periodically is as follows:

After the selected resource is used to transmit information on one HPB frequency continuously according to a preset duration of each HPB transmission, and transmission is shut off according to a preset interruption interval between two HPB transmissions. Then the frequencies are switched sequentially and the information on a subsequent HPB frequency is transmitted. The interruption interval between two HPB transmissions is the interruption interval between two successive transmissions.

In the embodiment of the present invention, when one resource is selected among the remaining resources used to transmit a traffic carrier frequency to transmit an HPB, the information on each HPB frequency includes SYNC, PAGING, and PILOT channel parameters. Therefore, the method in the embodiment of the present invention can direct an MS in the idle state to complete an inter-frequency handoff. In addition, in the method provided in the embodiment of the present invention, the SYNC and PAGING channel parameters can be transmitted using the remaining resources of the system and therefore no new costly device is required as in the prior art to transmit the SYNC and PAGING channels. Therefore, compared with the prior art, the embodiment of the present invention does not increase the system cost when directing an MS in the idle state to complete an inter-frequency handoff.

When an HPB frequency is added to the HPB cell, no other independent resource is allocated. Instead, the resource selected above is used to transmit the information on the new HPB frequency and all existing HPB frequencies rotationally and periodically, therefore saving the system overhead caused by the new HPB frequency.

When an HPB frequency is deleted from the HPB cell, the resource selected above continues transmitting information on all remaining HPB frequencies rotationally and periodically unless all HPB frequencies of the HPB cell are deleted. When all HPB frequencies of the HPB cell are deleted, the resource selected above is released and withdrawn.

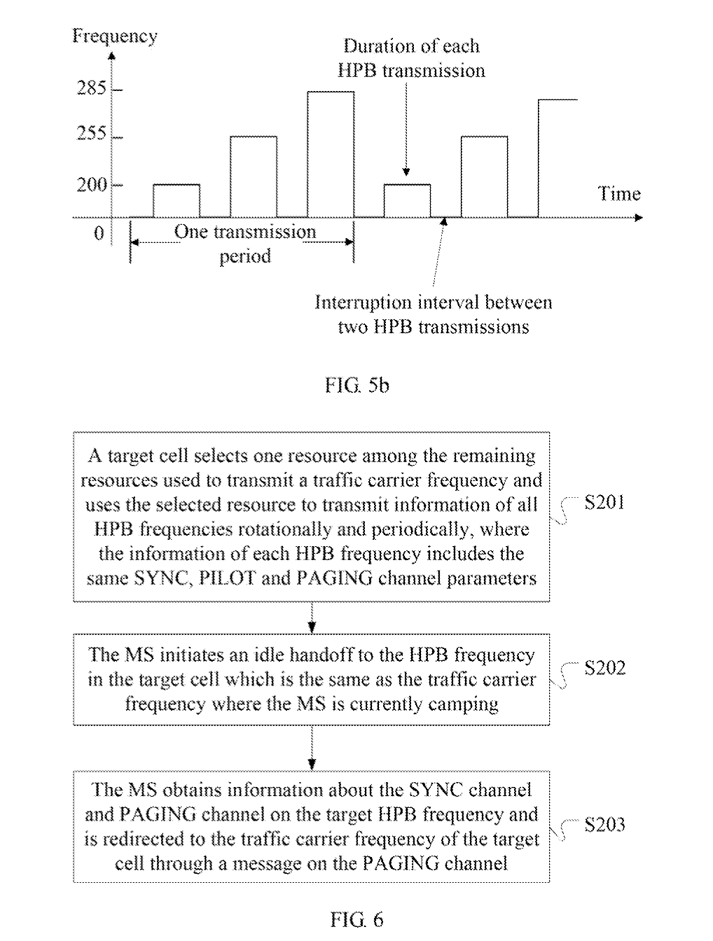

The following describes the method for transmitting an HPB provided in the embodiment of the present invention in a scenario where three HPB frequencies are available in an HPB cell, with reference to FIG. 5a and FIG. 5b.

As shown in FIG. 5a, one resource is first selected from idle baseband resources in the baseband resource pool made up of channel elements to encode, interleave, and modulate the information on the three HPB frequencies (a first HPB frequency, a second HPB frequency, and a third HPB frequency) of a same HPB cell and generate an output baseband signal that carries information on the three HPB frequencies. Three intermediate radio frequency carrier signals are generated according to the three HPB frequencies and the intermediate radio frequency carrier signals and the output baseband signal are superposed to be transmitted through an idle transceiver channel of the TRX or RRU. FIG. 5b shows the time sequence of transmitting information on the three HPB frequencies in the HPB cell. Specifically, the first HPB frequency information is transmitted for a period of time according to a preset duration of each HPB transmission, and the transmission is shut off for a period of time according to a preset interruption interval between two HPB transmissions. Then the transmission is switched to the second HPB frequency according to the transmitting sequence and steps similar to the transmission of the first HPB frequency proceed. The transmission is switched back to the first HPB frequency when the third HPB frequency is transmitted for a period of time and its transmission is shut off for a period of time.

In the above method, preferably, the multiple HPB frequencies of the same HPB cell are transmitted with slowly ascending power so that power control can be adjusted in time to reduce the interference of HPB transmission with the same traffic carrier frequencies in the neighbor cells.

When an MS in the idle state performs an inter-frequency handoff, the MS only needs to utilize the CCLM and the System Parameter Message (SPM) in the PAGING channel. When the PB is transmitted in a frequency hopping manner, that is, in HPB mode, the HPB signal hops to another frequency often before the MS collects the SPM and CCLM from the PAGING channel. The MS therefore must wait for a next cycle when the HPB signal hops back to the frequency to continue collecting the SPM and CCLM. To enable the MS to collect the SPM and CCLM quickly and further camp on the traffic carrier frequency of a target cell, the overhead of the PAGING channel of the HPB carrier is optimized so that only the CCLM and SPM are transmitted on the PAGING channel and that the CCLM and SPM are transmitted cyclically in one PAGING period.

An embodiment of the present invention provides a method for directing an MS in the idle state to complete an inter-frequency handoff. Assume that an MS camping on a traffic carrier frequency of the current cell moves from the current cell to a target neighbor cell and that the traffic carrier frequency of the target cell is different from that of the current cell. As shown in FIG. 6, the method includes the following steps:

Step S201: A target cell selects one resource among the remaining resources used to transmit a traffic carrier frequency; the selected resource is used to transmit the information on each of HPB frequencies rotationally and periodically and information on each HPB frequency includes the same SYNC, PILOT and PAGING channel parameters.

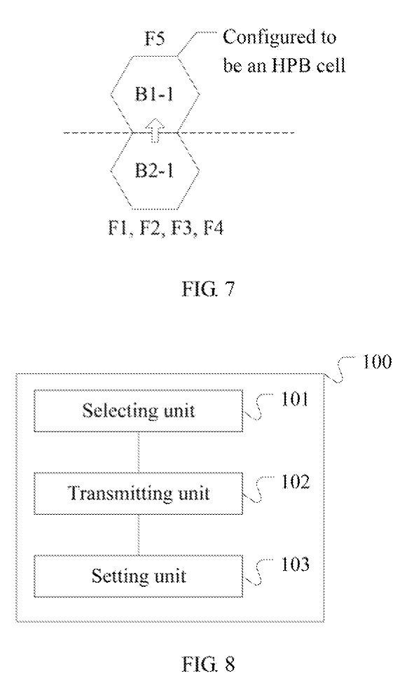

As shown in FIG. 7, it is assumed that the current cell is B2-1 and that the cell is covered by four traffic carrier frequencies F1, F2, F3, and F4. The MS camps on the traffic carrier frequency F2. The traffic carrier frequency of the target cell B1-1 is F5.

To enable the MS to switch from the traffic carrier frequency F2 of the current cell to the traffic carrier frequency F5 of the target cell, the target cell B1-1 is set to be an HPB cell and the four HPB frequencies F1, F2, F3, and F4 are transmitted in a frequency hopping manner. Specifically, one resource is selected among the remaining resources that are used to transmit a traffic carrier frequency in the target cell B1-1 to transmit the information on different HPB frequencies rotationally and periodically and the same SYNC, PILOT and PAGING channel parameters are set for all HPB frequencies.

Step S202: The MS initiates an idle handoff to the HPB frequency in the target cell which is the same as the traffic carrier frequency where the MS is currently camping.

A condition for the MS to initiate an idle handoff is: the MS measures the pilot strength of the HPB frequency in the target cell which is the same as the traffic carrier frequency where the MS is currently camping, and measures the pilot strength of the traffic carrier frequency where the MS is currently camping, and compares measurement results; if the former is greater than the latter, the MS initiates an idle handoff to switch to the HPB frequency of the target cell which is the same as the traffic carrier frequency where the MS is currently camping.

Taking the cells shown in FIG. 7 as an example, the MS measures the pilot strength of the HPB frequency F2 in the target cell B1-1 and compares the pilot strength with the measured pilot strength of the traffic carrier frequency in the current cell where the MS is currently camping. If the former is greater than the latter, the MS initiates an idle handoff to switch to the HPB frequency F2 of the target cell.

S203: The MS obtains information about the SYNC channel and PAGING channel on the target HPB frequency and is redirected to the traffic carrier frequency of the target cell through a message on the PAGING channel.

Taking the cells in FIG. 7 as an example, the MS obtains information about the SYNC channel and PAGING channel of the HPB frequency F2 of the target cell B1-1 and is redirected to the traffic carrier frequency F5 of the target cell B1-1 by getting the CCLM and PSM in the PAGING channel. Therefore, the MS in the idle state camps on the traffic carrier frequency of the target cell.

It should be noted that, in a scenario where the PB is not transmitted in a frequency hopping manner, because a pilot frequency signal is continuous, the MS may generally collect the SPM and CCLM within 60-100 ms after camping on the PB frequency, and camp on the traffic carrier frequency successfully. In a scenario where the PB is transmitted in a frequency hopping manner (HPB mode), when the MS switches to the HPB frequency of a target cell set as an HPB cell, the HPB signal hops to another frequency often before the MS completes collection of the SPM and CCLM from the PAGING channel and the MS must wait for another cycle when the HPB signal hops back to the frequency to continue collecting the SPM and CCLM, and the MS will not camp on the traffic carrier frequency of the target cell successfully until the SPM and CCLM are both collected. Currently, for the PAGING channel of a common carrier frequency, messages such as the SPM, CCLM, Neighbor List Message (NLM), Extend System Parameter Message (ESPM), Access Parameter Message (APM), and blank General Parameter Message are transmitted. But, messages useful for the camping policy in the embodiment of the present invention are only the SPM and CCLM. To enable the MS to camp on the traffic carrier frequency of the target cell quickly, an exemplary implementation is provided in an embodiment of the present invention, where the overhead of the PAGING channel of the HPB carrier is optimized so that only the CCLM and SPM are transmitted on the PAGING channel and that the CCLM and SPM are transmitted cyclically in one paging period. The MS therefore receives the required system information in a shorter time at the HPB frequency and thereby camp on the traffic carrier frequency of the target cell more quickly, therefore directing the MS to complete an inter-frequency handoff more quickly.

Corresponding to the method embodiments of the present invention, an embodiment of the present invention provides an HPB transmitting apparatus 100. As shown in FIG. 8, the apparatus includes:

a selecting unit 101, configured to select one resource among the remaining resources used to transmit a traffic carrier frequency;

a transmitting unit 102, configured to use the selected resource to transmit information on different HPB frequencies rotationally and periodically; and

a setting unit 103, configured to set the same SYNC, PILOT, and PAGING channel parameters in the transmitted information on HPB frequencies.

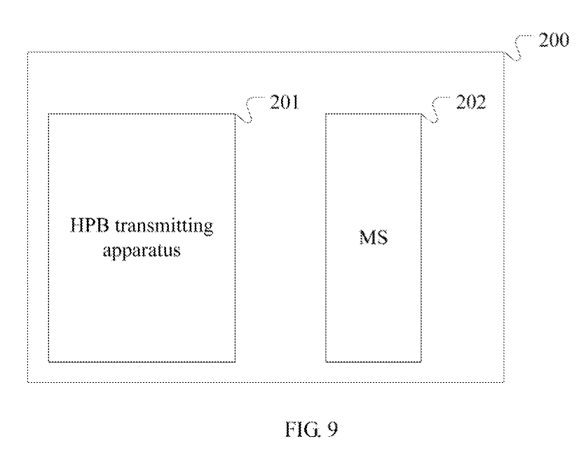

An embodiment of the present invention provides a communications system 200. As shown in FIG. 9, the system 200 includes: an HPB transmitting apparatus 201 and an MS 202.

The HPB transmitting apparatus 201 is configured to: select one resource among the remaining resources used to transmit a traffic carrier frequency; use the selected resource to transmit the information on different HPB frequencies rotationally and periodically; and set the same SYNC, PILOT and PAGING channel parameters in the transmitted information on HPB frequencies.

When an idle handoff is initiated, the MS 202 switches to an HPB frequency which is transmitted by the HPB transmitting apparatus 201 and is the same as the traffic carrier frequency where the MS is currently camping, obtains information about a SYNC channel and a PAGING channel on the target HPB frequency, and is redirected to the traffic carrier frequency of the target cell through a message in the PAGING channel.

Although the principle and implementation of the present invention have been described in detail through exemplary embodiments, the embodiments are only intended to help understand the method and core idea of the present invention. It is apparent that those skilled in the art can make various modifications and variations to the invention without departing from the scope of the invention. To sum up, the specification shall not be construed as a limitation to the present invention.

What is claimed is:

1. A method for transmitting a Hopping Pilot Beacon (HPB), comprising:
selecting, by an HPB cell, one resource among remaining resources used to transmit a traffic carrier frequency; and
using, by the HPB cell, the selected resource to transmit information on each of HPB frequencies rotationally and periodically, wherein:
the information on each of HPB frequencies comprises the same SYNC, PILOT, and PAGING channel parameters.

2. The method of claim 1, wherein the selected resource comprises:
a baseband resource, configured to process the information on different HPB frequencies and generate an output baseband signal that comprises the information on each of HPB frequencies; and
an intermediate radio frequency resource, configured to generate an intermediate radio frequency carrier signal according to the HPB frequencies and superpose and transmit the intermediate radio frequency carrier signal and the output baseband signal.

3. The method of claim 1, wherein there are multiple HPB frequencies and the selecting one resource to transmit information on each of HPB frequencies rotationally and periodically comprises:
transmitting information on one HPB frequency continuously according to a preset duration of each HPB transmission; and
shutting off the transmission according to a preset interruption interval between two HPB transmissions.

4. The method of claim 1, wherein the HPB frequencies are transmitted with slowly ascending power.

5. The method of claim 1, further comprising: when an HPB frequency is added to the HPB cell, transmitting information on each of HPB frequencies comprising the new HPB frequency rotationally and periodically;
when an HPB frequency is deleted from the HPB cell, transmitting information on all remaining HPB frequencies rotationally and periodically; and when all HPB frequencies in the HPB cell are deleted, releasing and withdrawing the resource selected to transmit information on the HPB frequencies rotationally and periodically.

6. The method of claim 5, wherein only a System Parameter Message (SPM) and a CDMA Channel List Message (CCLM) are transmitted on a PAGING channel of the HPB frequencies of the HPB cell and are transmitted cyclically in one paging period.

7. A method for directing a Mobile Station (MS) in an idle state to complete an inter-frequency handoff, comprising:
selecting, by a target cell, one resource among remaining resources used to transmit a traffic carrier frequency and using the selected resource to transmit information on all Hopping Pilot Beacon (HPB) frequencies rotationally and periodically, wherein the information on each HPB frequency comprises the same SYNC, PILOT and PAGING channel parameters;
initiating, by the MS, an idle handoff to an HPB frequency in the target cell which is the same as a traffic carrier frequency where the MS is currently camping; and
getting, by the MS, a SYNC channel and a PAGING channel on the target HPB frequency and being redirected to a traffic carrier frequency of the target cell through a message on the PAGING channel.

8. The method of claim 7, wherein the PAGING channel of all HPB frequencies of the target cell transmits only a System Parameter Message (SPM) and a CDMA Channel List Message (CCLM) and transmits the messages cyclically in one paging period.

9. The method of claim 7, wherein a condition for the MS to initiate the idle handoff is: the MS measures pilot strength of the HPB frequency in the target cell which is the same as the traffic carrier frequency where the MS is currently camping, measures the pilot strength of the traffic carrier frequency where the MS is currently camping, and compares the two measurement results, and if the measured pilot strength of the target cell is greater than the measured pilot strength of the traffic carrier frequency where the MS is currently camping, the MS initiates the idle handoff.

10. A Hopping Pilot Beacon (HPB) transmitting apparatus, comprising:
a selecting unit, configured to select one resource among remaining resources used to transmit a traffic carrier frequency;
a transmitting unit, configured to use the selected resource to transmit information on each of HPB frequencies rotationally and periodically; and
a setting unit, configured to set the same SYNC, PILOT, and PAGING channel parameters in the transmitted information on HPB frequencies.
